(19) United States
(12) Patent Application Publication
(10) Pub. No.: US 2026/0221933 A1
(43) Pub. Date: Jul. 30, 2026

(54) SYSTEM FORMING A TRANSPARENT SURFACE CAPTURING SOLAR ENERGY AND TRANSMITTING LIGHT USING MULTIPLE LENSES

(71) Applicants: Toyota Motor Engineering & Manufacturing North America, Inc., Plano, TX (US); Toyota Jidosha Kabushiki Kaisha, Toyota-shi Aichi-ken (JP)

(72) Inventors: Songtao Wu, Ann Arbor, MI (US); Debasish Banerjee, Ann Arbor, MI (US); Brian K. Woods, Brighton, MI (US); Ryota Tomizawa, Shizuoka-ken Susono-shi (JP); Shinya Iwasaki, Mizuho City (JP)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/039,103

(22) Filed: Jan. 28, 2025

(51) Int. Cl. H02S 40/22; G02B 3/00; G02B 19/00

(52) U.S. Cl. CPC H02S 40/22; G02B 3/005; G02B 19/0009; G02B 19/0076

(57) ABSTRACT

Systems described herein relate to forming a transparent surface having solar material that harvests energy according to multiple lenses directing light. In one embodiment, a system includes a first lens that directs incident light within a first angular range for absorption and a second angular range for transmission to an interior environment. The system also includes transparent material within predetermined areas associated with the first lens that transmit the incident light from the second angular range towards the interior environment. The system also includes absorption components being located outside the predetermined areas capturing energy from the incident light within the first angular range, the absorption components being hidden at the second angular range from an exterior view. The system also includes a second lens that is aligned with the transparent material and the absorption components, the second lens transmitting the incident light to the interior environment.

### TECHNICAL FIELD

The subject matter described herein relates, in general, to an energy capture system that is angle-dependent, and, more particularly, to the system forming a transparent surface having solar material that harvests energy according to multiple lens directing light.

### BACKGROUND

Systems and methods can capture and harvest solar energy to power electronic devices and lighting within buildings. Such systems can generate continuous power for an electronic device and store energy for future usage. In one approach, photovoltaic material encapsulated in other materials (e.g., glass) form solar cells that react to light rays. The photovoltaic material releases electrons and generates an electric charge when exposed to photons from the light rays. A controller can output the electric charge as a direct current (DC) that directly powers a home, building, etc. An inverter can also transform the DC to alternating current (AC) as inputs demanded by power panels in certain countries. Systems accumulate the electric charge through combining solar panels that are extensive and sizable for powering devices such as homes, commercial buildings, lights, and small appliances. As such, output power from the devices capturing the solar energy is correlated with the size and density of solar cells. Systems having a limited quantity of solar cells reduce capabilities to power demanding loads.

In various implementations, systems that form an array of panels having solar cells increase capture density and areas that capture solar energy. A farm of solar arrays can power a neighborhood. An installation covering the size of a roof can power certain electronics and appliances in a house. These systems can exhibit poor appearances and aesthetics that limit installation sizes. Similarly, consumer and commercial products integrating a solar panel can face obstacles from poor aesthetics and design options. For instance, a system hides areas components of a solar panel for a computing device to improve look and feel. This reduces capture areas for energy harvesting that hinders power output levels. Thus, systems powering devices using solar energy face challenges for outputting power due to aesthetics and designs that hinder implementation options.

In one embodiment, example systems relate to forming a transparent surface having solar material that harvests energy according to multiple lenses directing light. In various implementations, photovoltaic material forming cells exhibit poor aesthetics when utilized as building materials. For example, windows with integrated solar cells have unattractive properties, thereby limiting system sizes for devices having demanding power requirements. Such windows can also block light that wastes capture capabilities. Furthermore, zoning and commercial laws limit size and locations on buildings for solar installations. Therefore, designing windows and other building products incorporating solar cells can be hindered by aesthetics and forms that block light.

Therefore, in one embodiment, a system has a transparent surface for a structure including absorption components in areas that capture solar energy and other areas that transmit light to an interior environment. In one approach, a lens passes light inside a structure at an angular range such that the interior environment is visible while the absorption components are hidden. Here, the absorption components can be selectively applied to the lens within the areas for capturing incident light at a certain angular range. Furthermore, another lens inside the structure can allow views to an exterior environment by transmitting interior light through a lens and avoiding the absorption components. As such, the system can function as a multi-purpose surface that captures solar energy. For instance, the system is a transparent shade with additional features that allow a bi-directional view between inside the structure and the external environment while concurrently harvesting solar power. Meanwhile, the system also hides the absorption components at certain views from the external environment at the angular range. In this way, the system allows for improved aesthetic integration with high output power from energy harvesting.

In one embodiment, a system forming a transparent surface having solar material that harvests energy according to multiple lenses directing light is disclosed. The system includes a first lens that directs incident light within a first angular range for absorption and a second angular range for transmission to an interior environment. The system also includes transparent material within predetermined areas associated with the first lens that transmits the incident light from the second angular range towards the interior environment. The system also includes absorption components being located outside the predetermined areas capturing energy from the incident light within the first angular range, the absorption components being hidden at the second angular range from an exterior view. The system also includes a second lens that is aligned with the transparent material and the absorption components, the second lens transmitting the incident light to the interior environment within a third angular range and transmitting interior light to an exterior environment.

In another embodiment, a system forming a transparent surface having solar material that harvests energy according to multiple lenses directing light is disclosed. The system includes a lens that directs incident light within a first angular range for absorption and a second angular range for displaying an image by transmitting the incident light. The system also includes an electronic display outputting the image that is viewable at the second angular range. The system also includes transparent material within predetermined areas associated with the lens that transmits the incident light from the second angular range towards the electronic display. The system also includes absorption components being located outside the predetermined areas capturing energy from the incident light within the first angular range, the absorption components being hidden at the second angular range from view. The system also includes the lens causing a visual effect on the image from directing the incident light within the first angular range towards the absorption components and the second angular range towards the transparent material.

In another embodiment, a system forming a transparent surface having solar material that harvests energy according to multiple lenses directing light is disclosed. The system includes a first lenticular lens that directs incident light within a first angular range for absorption and a second angular range for transmission to an interior environment. The system also includes transparent material within predetermined areas associated with the first lenticular lens that transmits the incident light from the second angular range towards the interior environment. The system also includes solar ink being located outside the predetermined areas capturing energy from the incident light within the first angular range, the solar ink being hidden at the second angular range from an exterior view. The system also includes a second lenticular lens that is aligned with the transparent material within the predetermined areas and the solar ink outside the predetermined areas, the second lenticular lens transmits the incident light to the interior environment within a third angular range and transmits interior light to an exterior environment.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a system forming a transparent surface having solar material that harvests energy according to multiple lenses directing light.

FIG. 2 illustrates examples of installing the system as a transparent shade for a building façade that captures solar energy while hiding absorption components.

FIG. 3 illustrates one embodiment of a display system forming a transparent surface having solar material that harvests energy and displays visual effects using an electronic display.

### DETAILED DESCRIPTION

Systems and other embodiments associated with forming a transparent surface having solar material that harvests energy using multiple lenses directing light are disclosed herein. In various implementations, solar cells having material that converts incident light to electric current exhibit unappealing designs and aesthetics when added to fenestration components for building exteriors and facades. Fenestration components allow transmitting light bi-directionally for natural and synthetic lighting. For instance, solar cells integrated within windows and doors have form factors, shapes, and packaging that are bulky and lack flexibility for installations and different building designs. Form factors and shapes having more attractive designs can interfere and obstruct light, thereby reducing capture efficiency. Form factors and packaging qualities can also limit the sizes of solar arrays and block incident light at certain angles when scaled, thereby wasting capture capabilities. Another challenge is art commissions and town engineers in historic areas requiring a permit to ensure conformity with existing exteriors and safety. Therefore, buildings and other systems incorporating solar cells have form factors and shapes that can lack appealing looks and block light.

Therefore, in one embodiment, a system on a structure has multiple lenses directing light bi-directionally where absorption components harvest solar energy at a first angular range and the system hides the absorption components at a second angular range while allowing transmission to an interior environment. Here, the absorption components (e.g., solar ink) can alternate with transparent material between the multiple lenses. For example, the transparent material is located within predetermined areas associated with a first lens that transmits the incident light from the second angular range toward the interior environment. Meanwhile, the absorption components are located outside the predetermined areas and capture energy from incident light within the first angular range. This allows the absorption components being unnoticeable and hidden at the second angular range from an exterior view outside the structure. A second lens inside the structure may be aligned with the transparent material within the predetermined areas and the absorption components outside the predetermined areas. This can allow transmitting the incident light to the interior environment and transmitting interior light to an exterior environment. Thus, the system has favorable aesthetic qualities for energy harvesting while functioning as a building surface that allows transmitting light bi-directionally.

In various implementations, a system has a lens directing light to absorption components harvesting solar energy at a first angular range and hiding the absorption components at a second angular range while displaying visual effects by an electronic display. Here, the electronic display may output an image that is viewable at the second angular range. Furthermore, the absorption components (e.g., solar ink) on the lens can alternate with clear and transparent material. As such, the lens causes a visual effect on the image from directing the incident light within a first angular range towards the absorption components and the second angular range towards the transparent material. Accordingly, the system generates visual effects that are vivid while capturing solar energy, thereby improving aesthetics, expanded installation areas, and applications for solar cells.

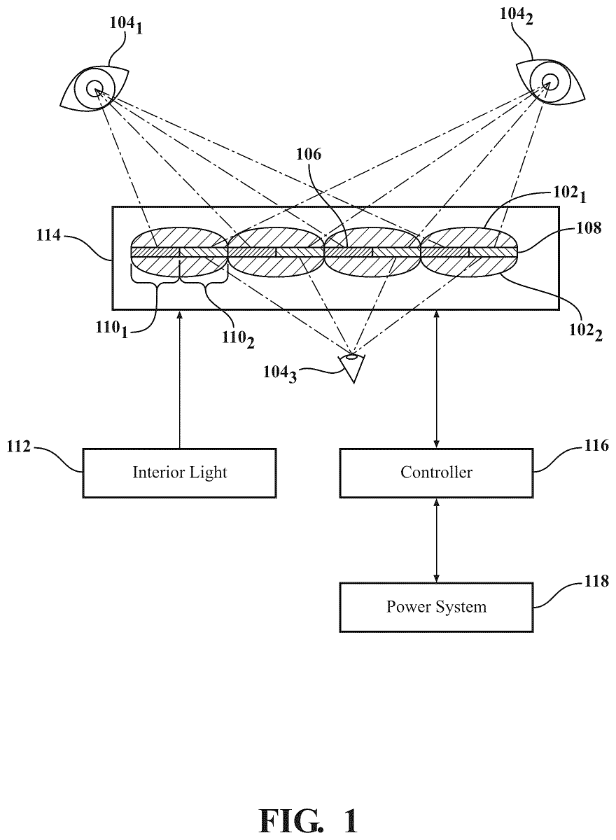

In certain implementations, the systems illustrated in FIGS. 1-3 also include various elements. It will be understood that in various embodiments, the systems may have less than the elements shown in FIGS. 1-3. The systems can have any combination of the various elements shown in FIGS. 1-3. Furthermore, the systems can have additional elements to those shown in FIGS. 1-3. In some arrangements, the systems may be implemented without one or more of the elements shown in FIGS. 1-3. While the various elements are shown as being located within the systems in FIGS. 1-3, it will be understood that one or more of these elements can be located external to the systems. Furthermore, the elements shown may be physically separated by large distances.

FIG. 1 illustrates one embodiment of a system forming a transparent surface having solar material that harvests energy according to multiple lenses directing light. In the forthcoming examples, the transparent surface can be partly, partially, substantially completely, etc., transparent. Further, the system may be installed on a building façade, a vehicle, a structure, etc., for absorbing solar energy while transmitting light depending upon angular ranges for incident light. In one approach, a first lens 102₁ directs incident light within a first angular range 104₁ for absorption and a second angular range 104₂ for transmission to an interior environment. Transparent material 108 within predetermined areas associated with the first lens 102₁ transmits the incident light from the second angular range 104₂ towards the interior environment. Furthermore, absorption components 106 are located outside the predetermined areas capturing energy from the incident light within the first angular range 104₁, the absorption components 106 being hidden at the second angular range 104₂ from an exterior view.

Moreover, a second lens 102₂ is aligned with the transparent material 108 within the predetermined areas and the absorption components 106 outside the predetermined areas, the second lens 102₂ transmitting the incident light to the interior environment within a third angular range 104₃ and transmitting light from an interior light 112 to an exterior environment. Here, the interior light can be from an artificial source, natural light, reflected light, etc. In one approach, the absorption components 106 are viewable through the second lens 102₂ within the interior environment outside of third angular range 104₃. As such, the second lens 102₂ allows incident light from the exterior environment to appear inside while blocking bi-directional light transmission at other angles, thereby increasing privacy.

Material properties and design of the first lens 102₁ and the second lens 102₂ allow controlling incident light such that certain angular ranges (e.g., bands) of the incident light travel through a transparent path to the absorption components 106, thereby increasing harvesting efficiency. In this way, the system improves aesthetics by being transparent at a viewing range from an exterior environment.

The absorption components 106 capture energy from the incident light within the first angular range 104₁ while otherwise being completely hidden, partially hidden, etc., at the second angular range 104₂. Here, the device being hidden creates a shade effect. In one approach, one or more of the absorption components 106 can form a cell capturing energy from incident light within the first angular range 104₁. Furthermore, subunits 110₁ and 110₂ can be areas associated with one of the first lens 102₁ and the second lens 102₂. Here, the transparent material 108 can exist within the subunits 110₂ while the absorption components 106 are located outside the subunits 110₂ within the subunits 110₁. The transparent material 108 may be an existing part of one of the first lens 102₁ and the second lens 102₂. As such, the absorption components 106 can apply thinly on a flat backing of the first lens 102₁ or the second lens 102₂ with the transparent material 108 being immeasurable, diminutive, etc. As further explained below, the transparent material 108 can be applied to either lens through printing that is precise and controlled. This allows the system to efficiently capture solar energy from light at certain incident angles while transmitting light to an interior environment and an exterior environment, thereby improving aesthetics and correspondingly expanding installation areas.

The system in FIG. 1 can be assembled by printing the absorption components 106 to one of the first lens 102₁ and the second lens 102₂ and bonding the lenses together. For example, the first lens 102₁ and the second lens 102₂ attach together using a bonding material, such as an optically clear adhesive. An optical adhesive can be clear and enhance transparency that mitigates absorption losses for energy. Furthermore, a printer can apply the transparent material 108 when lacking from one of the first lens 102₁ and the second lens 102₂. In this way, the system improves appearances while maintaining energy benefits for a structure by absorbing energy at certain angles while transmitting light bi-directionally at other angles.

In different embodiments throughout, angular ranges, bands, frequency ranges, etc., may be referenced as image bands that define angles at which the interior environment, exterior environment, etc., is viewable by a person, machine, etc. Furthermore, the second angular range 104₂ can represent transparent bands associated with one of areas, sections, etc., of the first lens 102₁ and the second lens 102₂. As such, the absorption components 106 capture energy from the incident light within the first angular range 104₁ while being completely hidden, partially hidden, etc., at the second angular range 104₂ and the transparent material 108 is visible, thereby increasing applications and improving looks for solar cells.

The first lens 102₁ and the second lens 102₂ can be waveguides that optically control and transmit incident light transparently toward the absorption components 106 and the transparent material 108. In one approach, the first lens 102₁ and the second lens 102₂ are lenticular lenses, lenticular films, etc., composed of a polyethylene terephthalate (PET), a polyethylene terephthalate glycol (PET-G), an epoxy slurry (ES), etc., material that is fully flexible, transparent, and forms waveguides that efficiently and clearly direct incident light towards the absorption components 106 and the transparent material 108. The lenticular lenses can also be acrylic material that is highly transparent and reflective at certain angles. In another approach, the lenticular film and the absorption components 106 are thin films that adapt with a structural shape unlike crystalline silicon. A thin film can be a photovoltaic material such as cadmium telluride (CdTe), copper indium gallium diselenide (CIGS), a perovskite-based film, etc., deposited on one of the first lens 102₁ and the second lens 102₂ and forming a solar cell in a layer. Thin films exhibit thinner profiles than wafers having crystalline silicon forming solar cells, thereby reducing weight and increasing flexibility. Irrespective of material composition, the lenticular lenses, the absorption components 106, and the transparent material 108 adapt to a structural shape through having certain transparent and flexible properties.

In another approach, the first lens 102₁ and the second lens 102₂ are lenticular waveguides with patterned features that control and direct the transmission of incident light. The lenticular waveguide can be an array of lenses that allows the visibility of interior and exterior environments at certain angles. Regarding details about applying the absorption components 106 to one of the first lens 102₁ and the second lens 102₂, the system can utilize a general printer, thereby reducing costs. Applications demanding high-resolution and precision can involve applying the absorption components 106 using a specialized printer. This approach can reduce ghosting and distortion from incident light being transmitted and absorbed by the absorption components 106 without interference, thereby improving view clarity among interior and exterior environments.

The absorption components 106 printed one of the first lens 102₁ and the second lens 102₂ (e.g., lenticular films) can be solar ink. Here, the solar ink can be directly printed to a lens that avoids unnecessary intermediate processing and materials during manufacturing. In one approach, the solar ink comprises flakes made from a film (e.g., a thin film). For example, the solar ink can be perovskite-based cured with ultraviolet (UV) light. This allows the solar ink to exhibit enhanced compatibility with various printers and printing methods. Perovskite-based solar ink can also improve bonding between the first lens 102₁ and the second lens 102₂. Similar to other examples, the absorption components 106 can be selectively located outside the subunits 110₂ within the subunits 110₁. For instance, the solar ink is independent and located outside the subunits 110₂. In this way, the solar ink absorbs energy at a first band while being out of sight and the transparent material 108 is visible at a second band. Thus, in FIG. 1 the solar ink and the transparent material 108 can form an alternating pattern, thereby reducing material costs through foregoing a full layer of the absorption components 106.

In another example, the absorption components 106 capture energy from the incident light within the first angular range 104₁. Otherwise, the absorption components 106 are completely hidden, partially hidden, etc., from sight and the transparent material 108 allows a viewer (e.g., a pedestrian) to see an interior environment. Here, the absorption components 106 can be hidden at the second angular range 104₂ from sight and located outside the subunits 110₂ within the subunits 110₁. The system having the absorption components 106 limited to the subunit 110₁ rather than the length of the first lens 102₁ or the second lens 102₂ saves material costs from avoiding a full length layer.

The flexibility of the system in FIG. 1 can include materials forming various shapes. For example, the first lens 102₁, the second lens 102₂, the absorption components 106 (e.g., solar ink), and the transparent material 108 fully curve to form a complete circle, a circular shape (e.g., 270-360 degrees), a polygon, etc. The fully flexible features benefit applications for a vehicle hood, roofs, a bus stop, advertising, etc. In one approach, device 114 houses the first lens 102₁, the second lens 102₂, the absorption components 106 (e.g., solar ink), and the transparent material 108. The flexibility of the device 114 expands applications and installation capabilities on curved roofs, shaded canopies, building components, lightposts, vehicle panels, vehicle rooftops, etc. As explained below, applications can include a solar shade, ceiling, transparent surface, etc., on a structure that is transparent and fully flexible. Accordingly, the system improves the aesthetics of structures and building components without obstructing solar rays, thereby increasing efficiency and power capture.

The device 114 can maintain precision and reduce costs through application within a limited number of printing passes (e.g., two, four, etc.) when using solar ink (e.g., perovskite-based ink). Printing passes continue until satisfying parameters for opaqueness and thickness of the absorption components 106. This can ensure that incident light does not transmit to the interior environment and interior light to the exterior environment, inadvertently risking privacy from unwanted views by outside observers.

In FIG. 1, the absorption components 106 and the transparent material 108 can be juxtaposed, alternating, etc., in a middle layer between the first lens 102₁ and the second lens 102₂. In various implementations, the absorption components 106 and the first angular range 104₁ represent an absorption band for capturing solar energy. Here, the absorption components 106 can alternate areas of solar ink for forming solar cells with areas having the transparent material 108. Furthermore, one of the first lens 102₁ and the second lens 102₂ can be composed of waveguide units shaped as one of a hemisphere, a demilune, a triangle, etc. The first lens 102₁ and the second lens 102₂ can be uniformly designed with various lenses per inch in different areas through extrusion and rolling during manufacturing. The design can also have shapes to have various curvatures for adapting with different installations, building types, and application demands. As previously explained, areas associated with one of the first lens 102₁ and the second lens 102₂ can be designated with subunits 110₁ and 110₂. The subunits 110₁ can represent an area having parts of the absorption components 106. The subunits 110₂ can be associated with the transparent material 108. As previously explained, material and design properties of the first lens 102₁ and the second lens 102₂ effect different angles of incident light directed to the subunits 110₁ and 110₂ for energy capture by the absorption components 106 and bi-directionally transmitting light through the transparent material 108.

The widths of the absorption components 106, the transparent material 108, the subunits 110₁, and the subunits 110₂ can vary depending upon demand for energy capture and visual design. For instance, the transparent material 108 has a first width X and the absorption components 106 has a second width Y. For example, the first width X and the second width Y comprise one of a 1:1 ratio, a 2:1 ratio, a 3:1 ratio, and a 1:3 ratio. A person of ordinary skill in the art understands that systems herein can also implement any ratio. As such, the system can be designed where increasing X increases light transmission and illumination in space while increasing Y increases energy capture.

The layers having the absorption components 106 and the transparent material 108 in FIGS. 1-3 are illustrations. For instance, the absorption components 106 and the transparent material 108 have minimal thickness when applied to the first lens 102₁. In this way, the first lens 102₁ is bonded evenly and flatly with the second lens 102₂.

Regarding further details about applications, the device 114 can be integrated into a building as fenestration (e.g., a window, a door, a shade, a transparent shade, etc.) for transmitting light through the transparent material 108 while capturing solar energy at certain angles. Here, solar rays at incident angles (e.g., 90-270 degrees) perpendicular and above a building wall are transmitted toward the absorption components 106 by diffusing through the first lens 102₁. The device 114 can be mounted at an angle, vertically, etc. Furthermore, the device 114 gives views of interior environments for observers at a certain angular range (e.g., 0-90 degrees) and makes the device 114 clear and substantially transparent through hiding the absorption components 106. In other words, a pedestrian approaching the building sees the interior environment through the first lens 102₁, the transparent material 108, and the second lens 102₂ transmitting incident light. Meanwhile, the absorption components 106 directly absorb solar energy at certain incident angles by unobstructed transmission through the first lens 102₁. This improves aesthetics for the absorption components 106 while increasing power capture through expanding installation capabilities. In this way, the system increases available installation areas and applications of systems for energy capture by enhancing attractiveness.

A controller 116 in FIG. 1 can regulate energy draw from the device 114 after bonding. The energy drawn is stored at power system 118. Similarly, a device, building, etc., can draw stored power from the power system 118. In various implementations, the controller 116 improves energy harvesting by adapting the orientation of the device 114 through different seasons as window shade, a transparent shading, etc., using actuators. For example, an actuator tilts the device 114 ten degrees toward the equator during the wintertime for capturing additional light more directly. Accordingly, the controller 116 regulates power and enhances the capabilities of the device 114 through motion that improves energy harvesting.

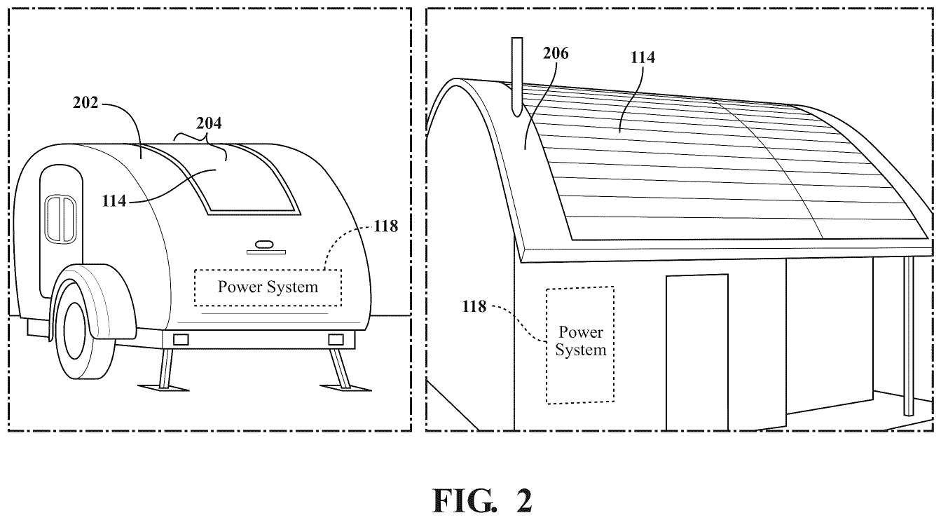

Now turning to FIG. 2, examples of installing the system as a transparent shade for a building façade that captures solar energy while hiding absorption components are illustrated. Here, the first lens 102₁, the second lens 102₂, the absorption components 106, and the transparent material 108 form one of a shade and a window for a structure. A trailer 202 has a curved structure and form of the device 114. In FIG. 2, the first lens 102₁ (e.g., an acrylic lenticular lens) can control incident light such that a bottom half is transparent, thereby allowing views into and out of the trailer 202. In other words, the device 114 is transparent and transmissive through hiding the absorption components 106 to an observer viewing the trailer 202 from the ground. As such, certain angles of light appear inside while the device blocks others.

Regarding absorption, the device 114 has the absorption components 106 that capture incident light from the exterior outside the trailer 202. In other examples, the device 114 is installed on a building, structure, etc. The power system 118 can power devices for the trailer 202 and store captured energy. Internally, the trailer 202 in one embodiment positions the absorption components 106 at viewable angles from an inside observer by having a flatter area 204 over a bedroom, storage area, etc. The flatter area 204 can exhibit an obtuse viewing angle over the bedroom, storage area, etc. For example, the flatter area 204 is a ceiling to the bedroom where darkness and privacy from the exterior environment are beneficial.

The transmission of light by the first lens 102₁ and the second lens 102₂ may be similar for areas covering the flatter area 204. In other examples, first and second angular ranges may be similar, equal, etc., to simplify manufacturing of the first lens 102₁ and the second lens 102₂.

Moreover, the building 206 has the device 114 functioning as a skylight and ceiling. Here, the building 206 (e.g., a modular house) has a first portion of the device 114 having the first lens 102₁, the transparent material 108, and the absorption components 106 located at a roof. The absorption components 106 may be visible from a viewpoint on the roof for absorbing solar power. A second portion of the device 114 is located on a side of the building 206 such that the absorption components 106 can be hidden from the exterior view on the side.

For the building 206, the device 114 captures solar energy at a first angular range and stores the solar energy within the power system 118. Devices within the building 206 can power through drawing current from the power system 118. The device 114 is a ceiling since light is inhibited by bi-directionally transmitting at a first angular range. As such, an inside observer sees a dark ceiling at certain viewing angles, thereby allowing privacy. This also allows applications for the device 114 functioning as a roof. The device 114 allows views into the building 206 from an outside observer and functions as the skylight at a second angular range. Accordingly, the device 114 installed on the building 206 has an appealing design and functionality through functioning as a ceiling and skylight that transmit light while capturing solar energy at certain angles.

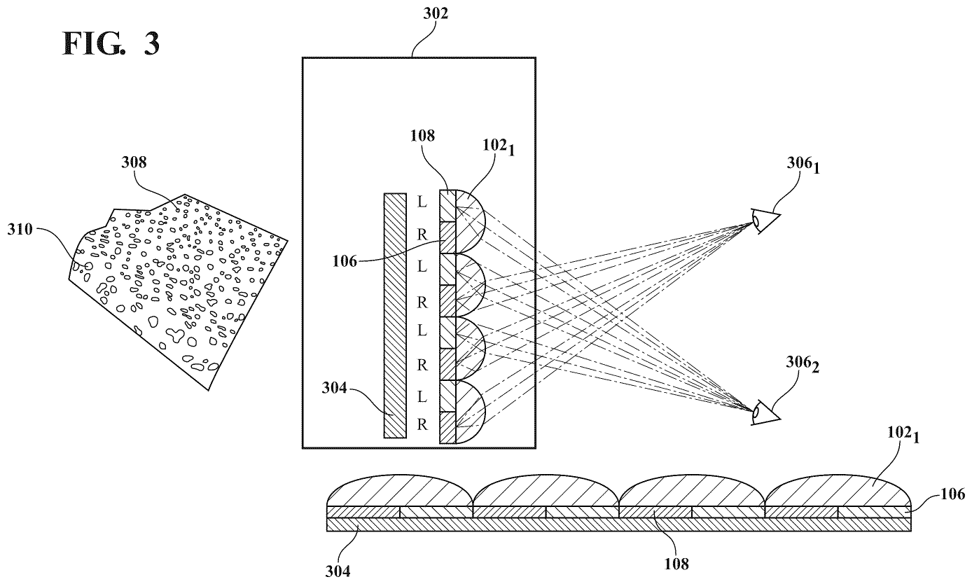

Regarding FIG. 3, one embodiment of a system 302 forming a transparent surface having solar material that harvests energy and displays visual effects using an electronic display 304 is illustrated. The system 302 includes a first lens 102₁ that directs incident light within a first angular range 306₁ for absorption and a second angular range 306₂ for displaying an image by transmitting the incident light. The electronic display 304 can output the image that is viewable at the second angular range 306₂. In one approach, the first angular range 306₁ represents a rightward viewpoint and the second angular range 306₂ represents a leftward viewpoint. In another example, the first angular range 306₁ represents a top viewpoint and the second angular range 306₂ represents a bottom viewpoint, a ground viewpoint, etc.

As previously explained, the transparent material 108 within predetermined areas associated with the first lens 102₁ transmits the incident light from the second angular range 306₂ towards the electronic display 304. Similarly, the first lens 102₁ allows light emissions from the electronic display 304 for displaying the image. Furthermore, the absorption components 106 being located outside the predetermined areas capture energy from the incident light within the first angular range 306₁. For instance, the absorption components 106 are solar ink directly printed on the first lens 102₁ comprising one of particles, flakes, etc., made from a film that absorbs solar energy.

Moreover, as explained above, the solar ink and the transparent material 108 can form an alternating, juxtaposed, etc., pattern for capturing solar energy while causing a visual effect. As such, the visual effect improves aesthetics for systems harvesting solar energy. Furthermore, the system 302 can vary the visual effect (e.g., depth, realistic motion, etc.) from the transparent material 108 having a first width and the absorption components 106 near the transparent material 108 having a second width. For instance, the first width and the second width comprise one of a 1:1 ratio, a 2:1 ratio, a 3:1 ratio, and a 1:3 ratio. A person of ordinary skill in the art understands that systems herein can also implement any ratio.

In FIG. 3, the first lens 102₁ can be a lenticular surface, lens, etc., designed to direct light so that the absorption components 106 are hidden at the second angular range 306₂ from view. For example, the lenticular lens is one of a polymer, a PET material, PET-G material, an acrylic material, a polystyrene material, etc., that forms a waveguide. These materials exhibit flexible properties that allow the lenticular lens, the electronic display 304, the transparent material 108, and the absorption components 106 to adapt with a structural shape. Such materials can also be completely or partially transparent for the first lens 102₁ and the transparent material 108 that expands application capabilities to advertising, home, and vehicle environments. The flexibility also allows installations on disparate structural materials and buildings. In this way, the first lens 102₁ causes the visual effect on the image from directing the incident light within a first angular range 306₁ towards the absorption components 106 for energy harvesting, the second angular range 306₂ towards the transparent material 108, and allowing light emissions from the electronic display 304 when displaying the image via the transparent material 108.

In various implementations, the electronic display 304 can be one of a light-emitting diode (LED), a liquid crystal display (LCD), and an organic LED (OLED) display. For instance, the electronic display 304 is an OLED film that is partly transparent. In one approach, the system 302 gives a stereoscopic effect of an image outputted by the electronic display 304 when observed from the second angular range 306₂. Here, the image is viewable and unblocked with light transmitting through the transparent material 108. Furthermore, the stereoscopic effect can include dynamically changing colors for views from the second angular range 306₂, changing a size ratio between the first width and the second width, etc.

In FIG. 3, the device 308 is an example of the system 302 being curved and displaying visual effects. Here, a displayed image is visible without obstruction with specks 310 associated with the absorption components 106. In one approach, the first lens 102₁ on the device 308 can be configured such that the image is viewable from 70% of most viewing angles at a mounting height approximately that of an average human. At other viewing angles, the image is hidden and the absorption components 106 capture the majority of incident light for harvesting energy. In this way, the device 308 displays the image while the specks 310 capture solar energy as a power supply.

A bent form for the system 302 can include a portion having the first lens 102₁, the electronic display 304, the transparent material 108, and the absorption components 106 being curved to display the image at the second angular range 306₂. In this example, the absorption components 106 of the system 302 outputs power from absorbing the incident light at the first angular range 306₁ sufficient for powering the electronic display 304 and other devices. The flexibility of the system 302 can also extend to forming a complete circle using thin films for the electronic display 304, the transparent material 108, and the absorption components 106. Therefore, the system 302 generates visual effects that are captivating and vivid while capturing solar energy, thereby having a self-powered device that has diverse applications.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-3, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A system comprising:
a first lens that directs incident light within a first angular range for absorption and a second angular range for transmission to an interior environment;
transparent material within predetermined areas associated with the first lens that transmit the incident light from the second angular range towards the interior environment;
absorption components being located outside the predetermined areas capturing energy from the incident light within the first angular range, the absorption components being hidden at the second angular range from an exterior view; and
a second lens that is aligned with the transparent material and the absorption components, the second lens transmitting the incident light to the interior environment within a third angular range and transmitting interior light to an exterior environment.

2. The system of claim 1, wherein:
the absorption components are solar ink directly printed to one of the first lens and the second lens;
the solar ink comprises flakes made from a film; and
the solar ink and the transparent material form an alternating pattern.

3. The system of claim 2, wherein:
the film is a solar film that is one of copper indium gallium diselenide (CIGS) photovoltaic (PV) film and a perovskite-based film.

4. The system of claim 1, wherein:
the transparent material has a first width and the absorption components near the transparent material have a second width; and
the first width and the second width comprise one of a 1:1 ratio, a 2:1 ratio, a 3:1 ratio, and a 1:3 ratio.

5. The system of claim 1 further comprising:
a first portion of a device having the first lens, the transparent material, and the absorption components located at a roof of a building, the absorption components being visible from a viewpoint on the roof; and
a second portion of the device is located on a side of the building, the absorption components being hidden from the exterior view on the side.

6. The system of claim 1, wherein the first lens, the second lens, the absorption components, and the transparent material curve to form a complete circle.

7. The system of claim 1, wherein:
the first lens and the second lens are lenticular lenses;
the lenticular lenses are one of a polymer material, a polyethylene terephthalate (PET) material, and an acrylic material that forms a waveguide;
the lenticular lenses, the absorption components, and the transparent material adapt to a structural shape; and
the lenticular lenses are transparent and flexible.

8. The system of claim 1, wherein:
the second angular range equals the first angular range; and
the first lens, the second lens, the absorption components, and the transparent material form one of a shade and a window for a structure.

9. A system comprising:
a lens that directs incident light within a first angular range for absorption and a second angular range for displaying an image by transmitting the incident light;
an electronic display outputting the image that is viewable at the second angular range;
transparent material within predetermined areas associated with the lens that transmits the incident light from the second angular range towards the electronic display;
absorption components being located outside the predetermined areas capturing energy from the incident light within the first angular range, the absorption components being hidden at the second angular range from view; and
the lens causing a visual effect on the image from directing the incident light within the first angular range towards the absorption components and the second angular range towards the transparent material.

10. The system of claim 9, wherein:
the absorption components are solar ink directly printed on the lens;
the solar ink comprises particles made from a film; and
the solar ink and the transparent material form a juxtaposed pattern.

11. The system of claim 9, wherein:
the transparent material has a first width and the absorption components near the transparent material have a second width; and
the first width and the second width comprise one of a 1:1 ratio, a 2:1 ratio, a 3:1 ratio, and a 1:3 ratio, the visual effect varies from the first width and the second width.

12. The system of claim 9 further comprising:
a portion of a device having the lens, the electronic display, the transparent material, and the absorption components is curved to display the image at the second angular range; and
the absorption components of the device outputs power from absorbing the incident light at the first angular range.

13. The system of claim 9, wherein the lens, the electronic display, the transparent material, and the absorption components curve to form a complete circle.

14. The system of claim 9, wherein:
the lens is a lenticular lens;
the lenticular lens is one of a polymer, a polyethylene terephthalate (PET) material, and an acrylic material that forms a waveguide;
the lenticular lens, the electronic display, the transparent material, and the absorption components adapt to a structural shape; and
the lenticular lens is transparent and flexible.

15. The system of claim 9, wherein:
the electronic display is a film that is one of a light-emitting diode (LED), a liquid crystal display (LCD), and an organic LED (OLED) display; and
the electronic display is partly transparent.

16. A system comprising:
a first lenticular lens that directs incident light within a first angular range for absorption and a second angular range for transmission to an interior environment;
transparent material within predetermined areas associated with the first lenticular lens that transmits the incident light from the second angular range towards the interior environment;
solar ink being located outside the predetermined areas capturing energy from the incident light within the first angular range, the solar ink being hidden at the second angular range from an exterior view; and
a second lenticular lens that is aligned with the transparent material within the predetermined areas and the solar ink outside the predetermined areas, the second lenticular lens transmits the incident light to the interior environment within a third angular range and transmits interior light to an exterior environment.

17. The system of claim 16, wherein:
the solar ink is directly printed to one of the first lenticular lens and the second lenticular lens;
the solar ink comprises flakes made from a film; and
the solar ink and the transparent material form an alternating pattern.

18. The system of claim 17, wherein:
the film is a solar film that is one of copper indium gallium diselenide (CIGS) photovoltaic (PV) film and a perovskite-based film; and
the transparent material is an existing part of the first lenticular lens.

19. The system of claim 16, wherein:
the transparent material has a first width and the solar ink near the transparent material have a second width; and
the first width and the second width comprise one of a 1:1 ratio, a 2:1 ratio, a 3:1 ratio, and a 1:3 ratio.

20. The system of claim 16 further comprising:
a first portion of a device having the first lenticular lens, the transparent material, and the solar ink located at a roof of a building, the solar ink being visible from a viewpoint on the roof; and
a second portion of the device is located on a side of the building, the solar ink being hidden from the exterior view on the side.
